(19) United States
(12) Patent Application Publication
(10) Pub. No.: US 2026/0295992 A1
(43) Pub. Date: Oct. 1, 2026

(54) LIQUID DISCHARGE HEAD, LIQUID DISCHARGE APPARATUS, IMAGE FORMING APPARATUS, DRIVE CIRCUIT, AND DRIVE METHOD

(71) Applicant: Arata SUZUKI, Kanagawa (JP)

(72) Inventor: Arata SUZUKI, Kanagawa (JP)

(73) Assignee: Ricoh Company, Ltd., Tokyo (JP)

(21) Appl. No.: 19/544,319

(22) Filed: Feb. 19, 2026

(30) Foreign Application Priority Data
Mar. 26, 2025 (JP) 2025-051697

(51) Int. Cl. B41J 2/045

(52) U.S. Cl. CPC B41J 2/0451; B41J 2/04508; B41J 2/04563; B41J 2/0457; B41J 2/04581; B41J 2/04588

(57) ABSTRACT

A liquid discharge head includes: a nozzle plate having a nozzle to discharge a liquid; a channel plate having a pressure chamber communicating with the nozzle; a diaphragm defining a part of the pressure chamber; a piezoelectric element to vibrate the diaphragm to discharge the liquid in the pressure chamber from the nozzle; and a drive circuit configured to: apply, to the piezoelectric element, multiple drive pulses including a specific drive pulse within one printing cycle, to drive the piezoelectric element to vibrate the diaphragm; measure a first residual vibration generated in the piezoelectric element by the multiple drive pulses; compare: the first residual vibration measured from the piezoelectric element; and comparison data of a second residual vibration measured in advance by applying, to the piezoelectric element, the specific drive pulse among the multiple drive pulses.

### CROSS-REFERENCE TO RELATED APPLICATIONS

This patent application is based on and claims priority pursuant to 35 U.S.C. § 119(a) to Japanese Patent Application No. 2025-051697, filed on Mar. 26, 2025, in the Japan Patent Office, the entire disclosure of which is hereby incorporated by reference herein.

### BACKGROUND

### Technical Field

The present embodiment relates to a liquid discharge head, a liquid discharge apparatus, an image forming apparatus, a drive circuit, and a drive method.

### Related Art

There is a technique of determining (detecting) a state of a mechanism (liquid discharge head, nozzle, etc.) that discharges liquid. For example, the abnormality is detected by the attenuation time or the cycle fluctuation of the residual vibration signal voltage of the piezoelectric element for discharging the liquid. Alternatively, an abnormality is detected from the viscosity caused by the residual vibration.

In a configuration in which a long time until the signal attenuates is used for detection and a configuration in which detection is performed with a long pulse interval so as not to be affected by other vibrations, the detection time becomes long.

### SUMMARY

The present disclosure provides a liquid discharge head including: a nozzle plate having a nozzle to discharge a liquid; a channel plate having a pressure chamber communicating with the nozzle; a diaphragm defining a part of the pressure chamber; a piezoelectric element to vibrate the diaphragm to discharge the liquid in the pressure chamber from the nozzle; and a drive circuit configured to: apply, to the piezoelectric element, multiple drive pulses including a specific drive pulse within one printing cycle, to drive the piezoelectric element to vibrate the diaphragm; measure a first residual vibration generated in the piezoelectric element by the multiple drive pulses; compare: the first residual vibration measured from the piezoelectric element; and comparison data of a second residual vibration measured in advance by applying, to the piezoelectric element, the specific drive pulse among the multiple drive pulses; and determine a state of the nozzle based on a comparison between the first residual vibration and the comparison data.

The present disclosure further provides a drive circuit including: circuitry configured to: apply, to a piezoelectric element of a liquid discharge head, multiple drive pulses including a specific drive pulse within one printing cycle to drive the piezoelectric element; measure a first residual vibration generated in the piezoelectric element by the multiple drive pulses; compare: the first residual vibration measured from the piezoelectric element; and comparison data of a second residual vibration measured in advance by applying, to the piezoelectric element, the specific drive pulse among the multiple drive pulses; and determine a state of a nozzle of the liquid discharge head based on a comparison between the first residual vibration and the comparison data.

The present disclosure further provides a drive method including: applying, to a piezoelectric element of a liquid discharge head, multiple drive pulses including a specific drive pulse within one printing cycle to drive the piezoelectric element; measuring a first residual vibration generated in the piezoelectric element by the multiple drive pulses; comparing: the first residual vibration measured from the piezoelectric element; and comparison data of a second residual vibration measured in advance by applying, to the piezoelectric element, the specific drive pulse among the multiple drive pulses; and determining a state of a nozzle of the liquid discharge head based on a comparison between the first residual vibration and the comparison data.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram for describing an example of a cross section along a longitudinal direction of a liquid chamber of a recording head according to a first embodiment;

FIG. 2 is a diagram for describing an example of a cross section along a short direction of the liquid chamber of the recording head according to the first embodiment;

FIG. 3 is a diagram for describing an example of a head driver of an inkjet head according to the first embodiment;

FIG. 4 is a schematic configuration diagram illustrating an overall configuration of a mechanical unit of an image forming apparatus according to the first embodiment;

FIG. 5 is a plan view for describing an example of a main part of a mechanical unit included in the image forming apparatus according to the first embodiment;

FIG. 6 is a cross-sectional view illustrating another example of the configuration of the image forming apparatus according to the first embodiment;

FIG. 7 is a top view of the image forming apparatus according to the first embodiment;

FIG. 8 is a view illustrating an example of a relationship between a drive waveform and residual vibration;

FIG. 9 is a view illustrating a method of calculating residual vibration in a normal state;

FIG. 10 is a view illustrating a method of calculating residual vibration in an abnormal state;

FIG. 11 is a diagram illustrating a configuration example of a circuit for detecting abnormality of a liquid discharge head; and

FIG. 12 is a flowchart illustrating an example of determination processing according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of a drive circuit, a liquid discharge head, a liquid discharger, a liquid discharge apparatus, and an image forming apparatus will be described in detail with reference to the accompanying drawings.

### First Embodiment

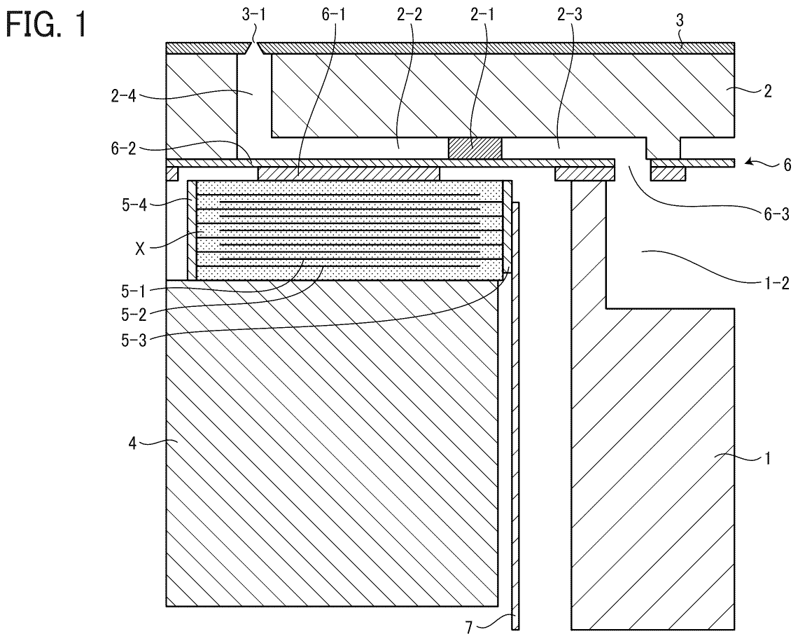

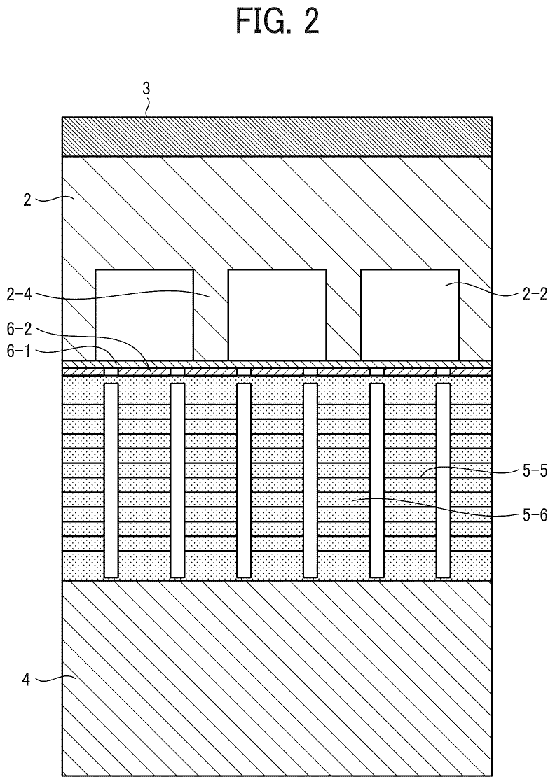

FIG. 1 is a diagram for describing an example of a cross section along a longitudinal direction of a liquid chamber of a recording head according to a first embodiment. FIG. 2 is a diagram for describing an example of a cross section along a short direction of the liquid chamber of the recording head according to the first embodiment.

A recording head (for example, an inkjet head) according to the present embodiment is an example of a liquid discharge head, and includes a frame 1, a channel plate 2, a nozzle plate 3, a diaphragm 6, a piezoelectric element X, a base 4, and the like. The frame 1 forms an engraving that becomes an ink supply port and a common liquid chamber 1-2. The channel plate 2 forms an engraving which forms a fluid resistance portion 2-1 and a pressurizing liquid chamber 2-2, and a communication port 2-3 communicating with the nozzle 3-1. The nozzle plate 3 forms the nozzle 3-1. The diaphragm 6 has a convex portion 6-1, a diaphragm portion 6-2, and an ink inflow port 6-3. The piezoelectric element (For example, a stacked piezoelectric element) X is bonded to the diaphragm 6 via a flexible printed circuit (FPC) 7. The base 4 fixes the piezoelectric element X. The piezoelectric element X is an example of a piezoelectric element that is driven by application of a drive waveform and discharges liquid from the nozzle 3-1.

The base 4 is made of a barium titanate-based ceramic, and two rows of piezoelectric elements X are arranged and joined. The piezoelectric element X is formed by alternately stacking a piezoelectric layer 5-1 of lead zirconate titanate (PZT) having a thickness of 10 to 50 μm/per layer and an internal electrode 5-2 made of silver/palladium (AgPd) having a thickness of several μm/per layer. The internal electrode 5-2 is coupled to the individual electrode 5-3 at both ends.

The piezoelectric element X is divided into comb teeth by half-cut dicing, and each of the piezoelectric elements X is used as a drive unit 5-5 and a support unit 5-6 (non-drive unit). The piezoelectric element X is obtained by alternately stacking the piezoelectric layer 5-1 of lead zirconate titanate (PZT) having a thickness of 10 to 50 μm/per layer and the internal electrode 5-2 made of silver/palladium (AgPd) having a thickness of several μm/per layer, and the internal electrode 5-2 is alternately electrically coupled to the individual electrode 5-3 and a common electrode 5-4 which are end surface electrodes (external electrodes) of an end surface.

Further, the inkjet head according to the present embodiment is configured to use the piezoelectric element X in the d33 system that is a thickness direction displacement, and the pressurizing liquid chamber 2-2 is contracted and expanded by expansion and contraction of the piezoelectric element X. The piezoelectric element X extends when a drive signal is applied and charging is performed, and contracts in the opposite direction when the charge charged in the piezoelectric element X is discharged.

The FPC 7 is solder-bonded to the individual electrode 5-3 of the drive unit 5-5. The common electrode 5-4 is bonded to the Gnd electrode of the FPC 7 by being provided along an electrode layer provided at the end of the piezoelectric element X. A driver integrated circuit (IC) is mounted on the FPC 7, thereby controlling application of a drive voltage to the drive unit 5-5.

In the diaphragm 6, a thin diaphragm portion 6-2, an island-shaped convex portion (island portion) 6-1 bonded to the piezoelectric element X to be the drive unit 5-5 formed at the central portion of the diaphragm portion 6-2, a thick film portion including a beam bonded to a support unit, and an opening to be the ink inflow port 6-3 are formed by overlapping two Ni plating films by an electroforming method.

In the channel plate 2, engraving which forms the fluid resistance portion 2-1, the pressurizing liquid chamber 2-2, and the communication port 2-3, and a through hole to be the communication port 2-3 at a position with respect to the nozzle 3-1 are patterned by an etching method using a silicon single crystal substrate. A portion left by the etching becomes a partition wall 2-4 of the pressurizing liquid chamber 2-2.

The nozzle plate 3 is formed of a metal material, for example, a nickel (Ni) plating film by electroforming, and a large number of nozzles 3-1, which are fine discharge ports for flying ink droplets, are formed in the nozzle plate 3. The internal shape (inner shape) of the nozzle 3-1 is formed in a horn shape (may be a substantially cylindrical shape or a substantially truncated cone shape).

The ink discharging surface (nozzle surface side) of the nozzle plate 3 is provided with a water-repellent treatment layer subjected to a water-repellent surface treatment. A water-repellent treatment film selected according to ink physical properties, such as polytetrafluoroethylene (PTFE)-Ni co-deposition plating, electrodeposition coating of a fluororesin, vapor-deposited coating of an evaporable fluororesin (for example, fluorinated pitch), baking after application of a solvent of a silicon-based resin or a fluororesin, is provided to stabilize the droplet shape and flight characteristics of the ink and obtain high quality image quality.

The frame 1 that forms the engraving that forms the ink supply port and the common liquid chamber 1-2 is manufactured by resin molding.

In the inkjet head configured as described above, by applying a drive waveform (for example, a pulse voltage of 10 to 50 V) to the drive unit 5-5 according to the recording signal, displacement in the stacking direction occurs in the drive unit 5-5, the pressurizing liquid chamber 2-2 is pressurized through the nozzle plate 3 to increase the pressure, and the ink droplets are discharged from the nozzle 3-1. Thereafter, with the completion of the ink droplet discharge, the ink pressure in the pressurizing liquid chamber 2-2 decreases, and a negative pressure is generated in the pressurizing liquid chamber 2-2 by the inertia of the ink flow and the discharge process of the drive pulse, and the processing proceeds to the ink filling process. At this time, the ink supplied from the ink tank flows into the common liquid chamber 1-2, passes through the communication port 2-3 and the fluid resistance portion 2-1 from the common liquid chamber 1-2 through the ink inflow port 6-3, and is filled into the pressurizing liquid chamber 2-2.

The fluid resistance portion 2-1 has an effect of attenuating residual pressure vibration after discharge, but becomes a resistance against maximum filling (refill) due to surface tension. By appropriately selecting the fluid resistance portion, the attenuation of the residual pressure and the refill time can be balanced, and the time (drive cycle) until the next ink droplet discharge operation can be shortened.

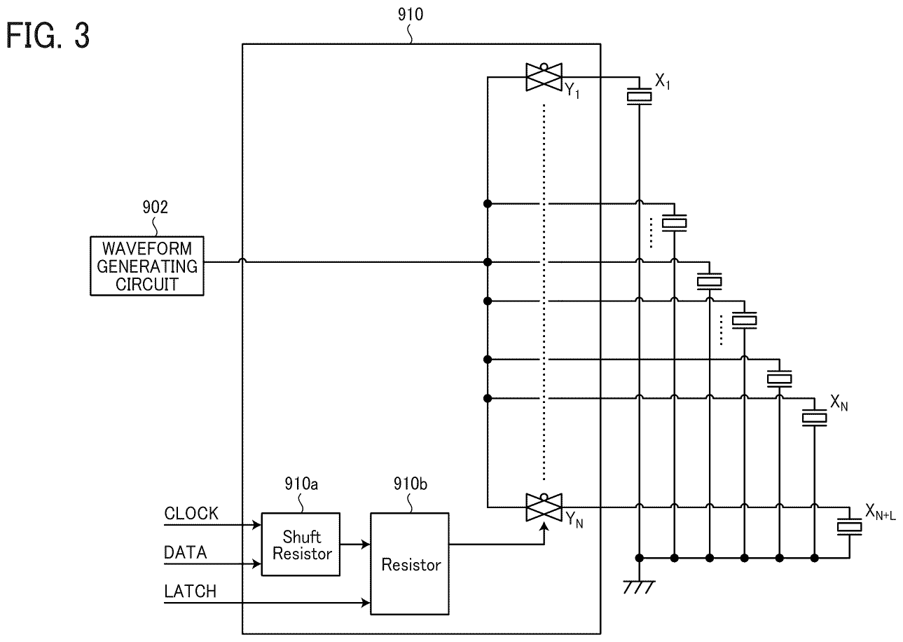

FIG. 3 is a diagram for describing an example of a head driver of an inkjet head according to the first embodiment. In the present embodiment, the head driver of the inkjet head includes a waveform generating circuit 902 and a head-module (Md) internal circuit 910. The waveform generating circuit 902 generates and outputs a drive waveform including multiple drive pulses (drive signals) within one printing cycle at the time of image formation. 3-bit image data (for example, gradation signal: 0, 1, 2) corresponding to a print image, a clock signal, and a latch signal (LAT) are input to the head-module (Md) internal circuit 910.

The head-module internal circuit 910 includes a shift register 910a, a latch circuit 910b, and an analog switch (ASW) Y. The shift register 910a receives image data and waveform data from a transfer clock (clock signal) and serial communication data from a data transfer unit. The latch circuit 910b latches each register value (image data, waveform data) of the shift register 910a by a latch signal. The analog switch Y selects a drive signal based on gradation data (image data) and applies the drive signal to the piezoelectric element X.

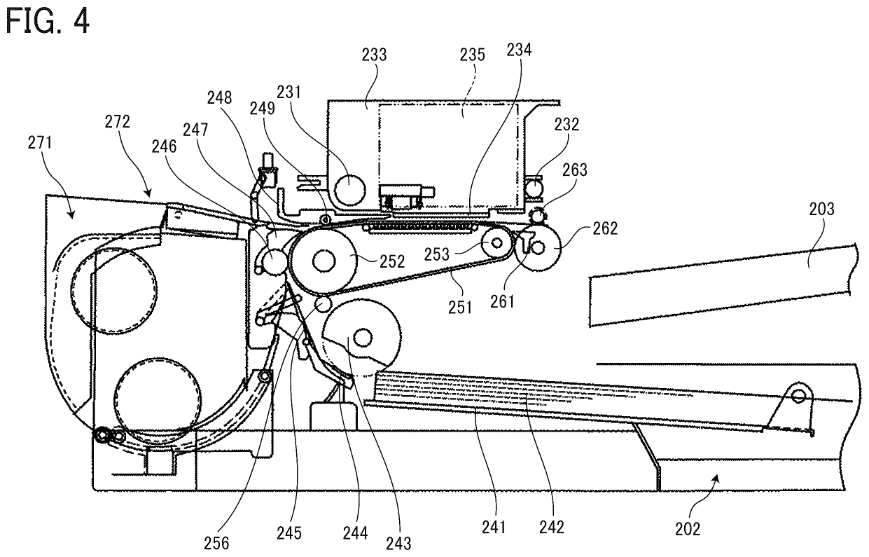

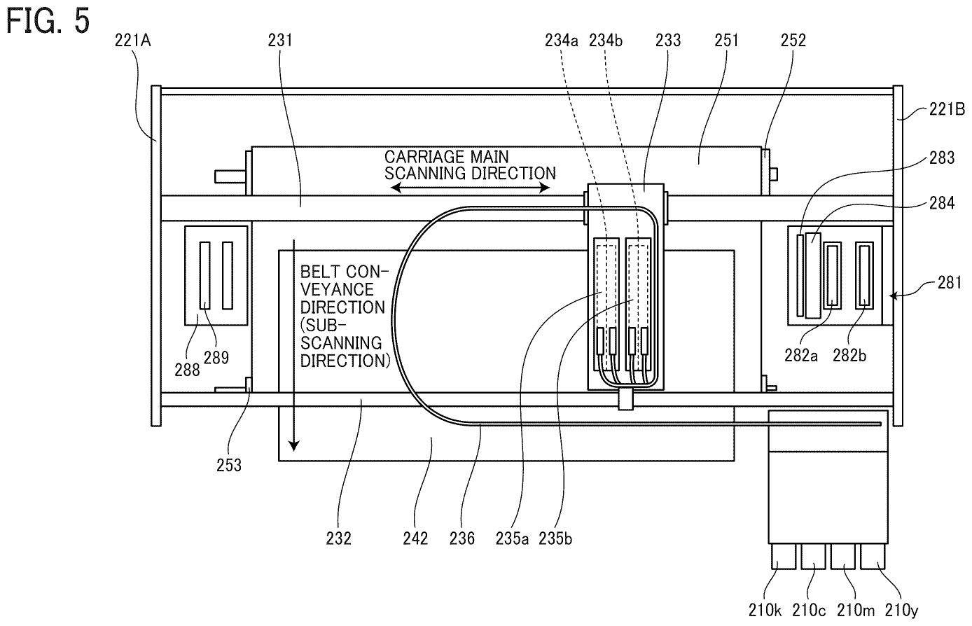

Next, an example of a serial image forming apparatus including a liquid discharge apparatus including a liquid discharge head (inkjet head) according to the present embodiment will be described with reference to FIGS. 4 and 5. FIG. 4 is a schematic configuration diagram illustrating an overall configuration of a mechanical unit of an image forming apparatus according to the first embodiment. FIG. 5 is a plan view for describing an example of a main part of a mechanical unit included in the image forming apparatus according to the first embodiment.

The image forming apparatus according to the present embodiment is a serial type image forming apparatus, in which a carriage 233 is slidably held in the main scanning direction by the main and sub guide rods 231 and 232 which are guide members laterally bridged on left and right side plates 221A and 221B, and a main scanning motor causes the carriage to move and scan in the arrow direction (carriage main scanning direction) via a timing belt.

On the carriage 233, recording heads 234a and 234b (when not distinguished, it is referred to as a recording head 234) as an example of a liquid discharge head that discharges ink droplets (example of liquid and droplet) of respective colors of yellow (Y), cyan (C), magenta (M), and black (K) are mounted such that a nozzle row including multiple nozzles is arranged in a sub-scanning direction orthogonal to the main scanning direction, and the ink droplet discharge direction is directed downward.

The recording head 234 has two nozzle rows, and one nozzle (nozzle 3-1) row of the recording head 234a discharges a black (K) droplet, the other nozzle row discharges a cyan (C) droplet, one nozzle row of the recording head 234b discharges a magenta (M) droplet, and the other nozzle row discharges a yellow (Y) droplet. The carriage 233 is mounted with head tanks 235a and 235b (when not distinguished, it is referred to as a head tank 235) for supplying ink of each color corresponding to the nozzle row of the recording head 234.

The ink of each color is replenished and supplied from the ink cartridges 210k, 210c, 210m, and 210y of each color to the head tank 235 through a supply tube 236 of each color. On the other hand, as a sheet feeder for feeding sheets 242 stacked on a sheet stacker (pressure plate) 241 of a sheet feeding tray 202, a rolling element (sheet feeding rolling element) 243 having a semicircular shape and separating and feeding the sheets 242 one by one from the sheet stacker 241, and a separation pad 244 made of a material having a large friction coefficient, which faces the sheet feeding rolling element 243, are provided, and the separation pad 244 is biased toward the sheet feeding rolling element 243.

In order to send the sheet 242 fed from the sheet feeder to the lower side of the recording head 234, a guide member 245 that guides the sheet 242, a counter roller 246, a conveyance guide member 247, and a pressing member 248 having a leading end pressing rolling element 249 are provided, and a conveyance belt 251 that is a conveyor for electrostatically attracting the fed sheet 242 and conveying the fed sheet at a position facing the recording head 234 is provided. The conveyance belt 251 is an endless belt and is stretched between a conveyance roller 252 and a tension roller 253 to rotate in a belt conveyance direction (sub-scanning direction).

A charging roller 256 which is a charging unit configured to charge the surface of the conveyance belt 251 is provided. The charging roller 256 contacts a surface layer of the conveyance belt 251 and rotates according to a rotation of the conveyance belt 251. The conveyance belt 251 circumferentially moves in the belt conveyance direction as the conveyance roller 252 is rotationally driven via a timing belt by the sub-scanning motor.

As the sheet ejector that ejects the sheet 242 recorded by the recording head 234, a separation claw 261 that separates the sheet 242 from the conveyance belt 251, a sheet ejection roller 262, and a sheet ejection rolling element 263 are provided, and a sheet ejection tray 203 is provided below the sheet ejection roller 262.

A double-sided unit 271 is detachably attached to a back surface portion of the apparatus main body. The double-sided unit 271 takes in the sheet 242 returned by the reverse rotation of the conveyance belt 251, reverses the sheet 242, and feeds the sheet 242 between the counter roller 246 and the conveyance belt 251 again. An upper surface of the double-sided unit 271 is a manual paper feeding tray 272.

A maintenance recovery mechanism 281 for maintaining and recovering the state of the nozzles of the recording heads 234 is disposed in a non-printing area on one side in the scanning direction of the carriage 233. The maintenance recovery mechanism 281 includes cap members for capping the nozzle surfaces of the recording head 234, a wiper blade 283 that is a blade member for wiping the nozzle surfaces, a dummy discharge receiver 284 that receives droplets when dummy discharge for discharging droplets that do not contribute to recording is performed in order to discharge thickened recording liquid, and the like. The cap member may be referred to as caps 282a and 282b and further collectively referred to as a cap 282.

In a non-printing area on the other side in the scanning direction of the carriage 233, an ink recovery unit (dummy discharge receiver) 288, which is a liquid recovery container that receives a droplet at the time of performing dummy discharge for discharging a droplet that does not contribute to recording in order to discharge a thickened recording liquid during recording, is disposed, and the ink recovery unit 288 includes an opening 289 and the like along the nozzle row direction of the recording head 234.

In the image forming apparatus configured as described above, the sheet 242 is separated and fed one by one from the sheet feeding tray 202, and the sheet 242 fed substantially vertically upward is guided by the guide member 245, sandwiched and conveyed between the conveyance belt 251 and the counter roller 246, further guided by a conveyance guide at the leading end, pressed against the conveyance belt 251 by the leading end pressing rolling element 249, and changed in the conveyance direction by approximately 90°.

At this time, a positive output and a negative output are alternately repeated with respect to the charging roller 256, that is, an alternating voltage is applied, and the conveyance belt 251 is alternately charged in a charging voltage pattern, that is, alternately charged with positive and negative forming stripes with a predetermined width in the sub-scanning direction which is the circumferential direction. When the sheet 242 is fed onto the conveyance belt 251 that is alternately charged with positive and negative voltages, the sheet 242 is attracted to the conveyance belt 251, and the sheet 242 is conveyed in the sub-scanning direction by the circular movement of the conveyance belt 251.

Then, the recording head 234 is driven according to an image signal while moving the carriage 233 to discharge ink droplets to the sheet 242, which is stopped, to record a single line of the image. After that, the sheet 242 is conveyed by a predetermined amount, and then the next line of the image is recorded. In response to reception of a recording end signal or a signal indicating that the trailing end of the sheet 242 has reached a recording area, the recording operation is terminated and the sheet 242 is ejected to the sheet ejection tray 203.

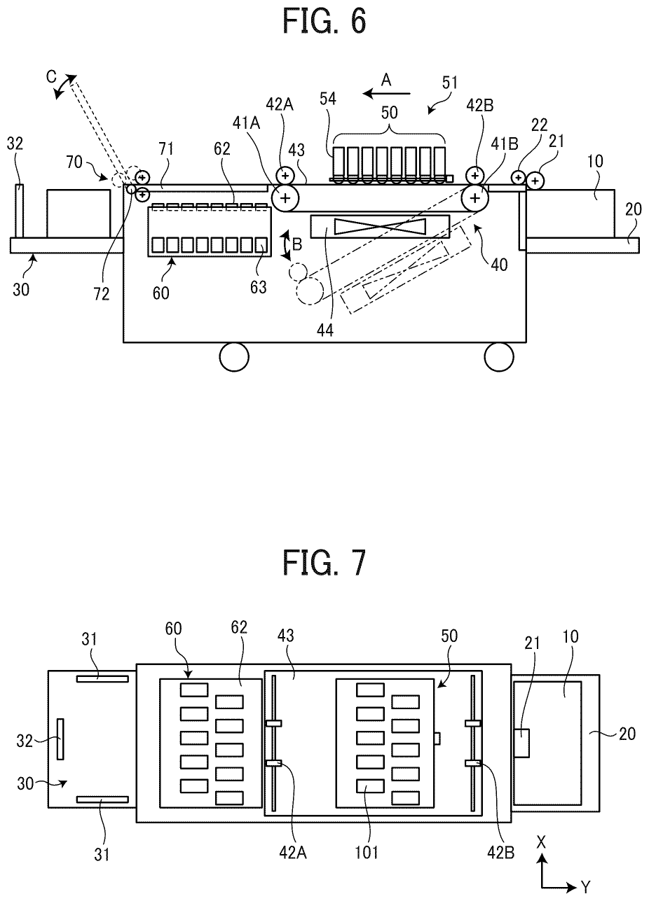

FIG. 6 is a cross-sectional view illustrating another example of the configuration of the image forming apparatus according to the first embodiment.

FIG. 7 is a top view of the image forming apparatus according to the first embodiment. As illustrated in FIGS. 6 and 7, the image forming apparatus according to the present embodiment is a line-type image forming apparatus, and includes: an apparatus main body; a sheet feeding tray 20 that loads and feeds a sheet 10; a sheet ejection tray 30 that ejects and stacks a printed sheet 10; a conveyor 40 that conveys the sheet 10 from the sheet feeding tray 20 to the sheet ejection tray 30; an image forming unit 51 including a head module array 50 constituting a recording head 101 that ejects and prints droplets (liquid) such as ink on the sheet 10 conveyed by the conveyor 40; a head cleaning device 60 that is a maintenance recovery mechanism that maintains and recovers multiple heads of each head module array 50 of the image forming unit 51 after completion of printing or at a required timing; a conveyance guide unit 70 that opens and closes the head cleaning device 60; and an ink supply system including a sub tank and a main tank that supply ink to the head module array 50 of the image forming unit 51. Note that the sheet 10 as a recording medium is not limited to paper, and a sheet made of another material such as an overhead projector (OHP) sheet is also used.

The apparatus main body includes a front-rear side plate, a stay, and the like, and the sheets 10 stacked on the sheet feeding tray 20 are fed to the conveyor 40 one by one by a separation roller 21 and a sheet feeding roller 22. The conveyor 40 includes a conveyance driving roller 41A, a conveyance driven roller 41B, and an endless conveyance belt 43 wound around the conveyance driving roller 41A and the conveyance driven roller 41B. Multiple suction holes are formed on the surface of the conveyance belt 43, and a suction fan 44 that sucks the sheet 10 is disposed below the conveyance belt 43. In the upper portion of the conveyance driving roller 41A and the conveyance driven roller 41B, conveyance guide rollers 42A and 42B are held by guides, and are in contact with the conveyance belt 43 by their own weight.

The conveyance belt 43 circumferentially moves when the conveyance driving roller 41A is rotated by the motor, and the sheet 10 is sucked onto the conveyance belt 43 by the suction fan 44 and conveyed by the circular movement of the conveyance belt 43. Note that the conveyance driven roller 41B and the conveyance guide rollers 42A and 42B rotate following the conveyance belt 43.

The image forming unit 51 including a head module array 50 that discharges droplets to be printed on the sheet 10 is disposed in an upper portion of the conveyor 40 so as to be movable in the direction of arrow A (and the opposite direction). The image forming unit 51 is moved to the upper side of the head cleaning device 60 at the time of the maintenance and recovery operation (at the time of cleaning), and is returned to the position of FIG. 6 at the time of image formation.

The image forming unit 51 includes a head module array 50 constituting a line type recording head that discharges droplets of ink (yellow Y, magenta M, cyan C, and black K) for four colors onto the sheet 10 attracted and held on the conveyance belt 43 and conveyed. In the head module array 50, branching members 54 that distribute and supply ink to the recording heads 101 of each row are integrally provided. Ink is supplied from the sub tank to the branching member 54, and ink is supplied from the main tank to the sub tank. Note that the ink color to be used is not limited to these four colors, and a color such as red, green, blue, or gray may be added to enlarge the range of colors or gradations to be reproduced.

The recording heads 101 are arranged such that one or more nozzles 3-1 at ends of two adjacent recording heads 101 (an example of a liquid discharge head) in the head arrangement direction (X direction in FIG. 7, direction orthogonal to sheet conveyance direction) overlap each other. Thus, recording can be performed at the same recording position (dot position) by the nozzles 3-1 of each of the two recording heads 101. The nozzle 3-1 at the end of the recording head 101 that can perform recording at the same recording position is referred to as an overlapping nozzle 3-1, and the region of the overlapping nozzle 3-1 is referred to as a joint portion, a nozzle-row overlapping portion, a nozzle-overlapping area (or portion), or an overlapping area (or portion).

On the downstream side of the conveyor 40, the conveyance guide unit 70 that ejects the sheet 10 to the sheet ejection tray 30 is provided. The sheet 10 guided and conveyed by the conveyance guide unit 70 is ejected to the sheet ejection tray 30. The sheet ejection tray 30 includes a pair of side fences 31 that regulates the width direction of the sheet 10 and an end fence 32 that regulates the leading end of the sheet 10.

The head cleaning device 60 is a maintenance recovery mechanism, and includes a cap member 62 and a wiper member corresponding to each recording head 101 of the image forming unit 51, and a suction pump 63 for sucking ink from the nozzle 3-1 in a state where a nozzle surface (surface on which the nozzle 3-1 is formed) of the nozzle 3-1 included in the recording head 101 is capped with the cap member 62.

In this image forming apparatus, when ink is sucked from the nozzle 3-1 in a state where the nozzle surface of the nozzle 3-1 included in the recording head 101 that discharges the droplets is capped with the cap member 62 of the head cleaning device 60 after the printing is finished, or when the ink attached to the nozzle surface of the nozzle 3-1 of the recording head 101 is cleaned with the wiping member, as also illustrated in FIG. 6, the entire conveyor 40 rotates in the direction of the arrow B with the conveyance driven roller 41B as a fulcrum after the printing is stopped, and a space between the conveyor 40 and the image forming unit 51 is made larger than the space at the time of image formation, so that the movement space of the image forming unit 51 is secured. At this time, a conveyance guide plate 71 of the conveyance guide unit 70 disposed above the head cleaning device 60 is also rotated upward in the arrow C direction at a fulcrum 72, and the upper side of the head cleaning device 60 is opened.

Then, after the conveyor 40 and the conveyance guide unit 70 are released, the image forming unit 51 moves in the sheet passing direction (direction of arrow A), is stopped above the head cleaning device 60, and the cap member 62 and the like move upward to perform a cleaning operation (maintenance and recovery operation) of the recording head 101.

Next, a method for determining a state using residual vibration of the piezoelectric element X will be described. As described above, in the present embodiment, a drive waveform including multiple drive pulses is applied to the piezoelectric element X within one printing cycle. In the present embodiment, the residual vibration generated by one drive pulse (single pulse) in the normal state (normal time) is stored in advance. The residual vibration (subtraction data) generated by the drive pulse excluding the single pulse is calculated by subtracting the residual vibration by the single pulse from the composite wave of the residual vibration by the multiple drive pulses. Then, the state is determined from the gradient value and the voltage value obtained from the multiple calculated amplitudes of the residual vibration.

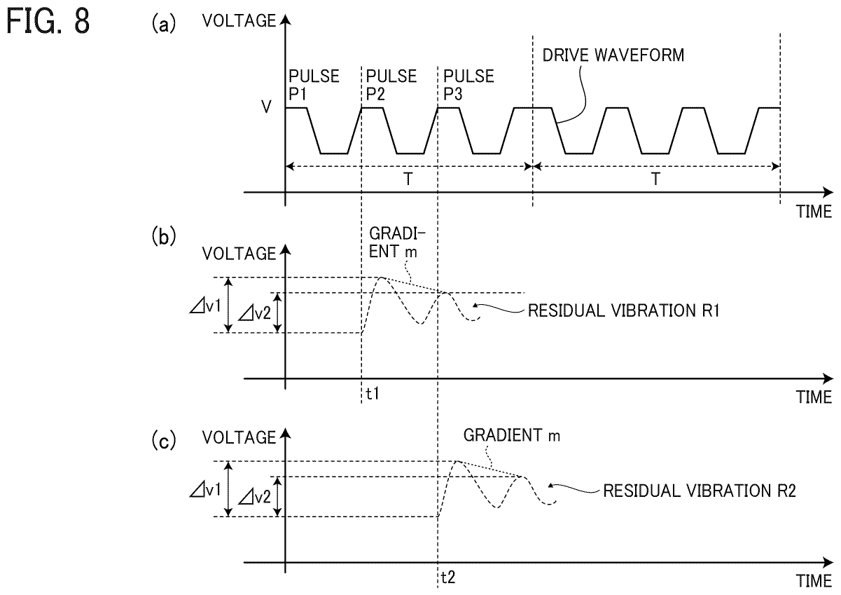

FIG. 8 is a view illustrating an example of a relationship between a drive waveform and residual vibration. The upper graph illustrates an example of the drive waveform. FIG. 8 illustrates an example of a drive waveform including pulses P1 to P3 which are three drive pulses within one printing cycle (cycle T). The number of drive pulses within the cycle T is not limited to three.

The middle graph and the lower graph illustrate examples of residual vibration R1 caused by the pulse P1 and residual vibration R2 caused by the pulse P2, respectively. Hereinafter, the amplitude of the voltage of the first vibration of the residual vibration may be expressed as Δv1, the amplitude of the voltage of the second vibration may be expressed as Δv2, and the gradient between the amplitudes of the voltages of the first vibration and the second vibration may be expressed as m. The gradient m corresponds to the gradient of a line segment connecting the maximum value of the amplitude of the voltage of the first vibration and the maximum value of the amplitude of the voltage of the second vibration.

When the residual vibration does not fluctuate due to an abnormality or a failure of the nozzle 3-1 during the discharge of the ink droplets, that is, when the nozzle 3-1 is normally operating, the residual vibration R1 and the residual vibration R2 become the same vibration.

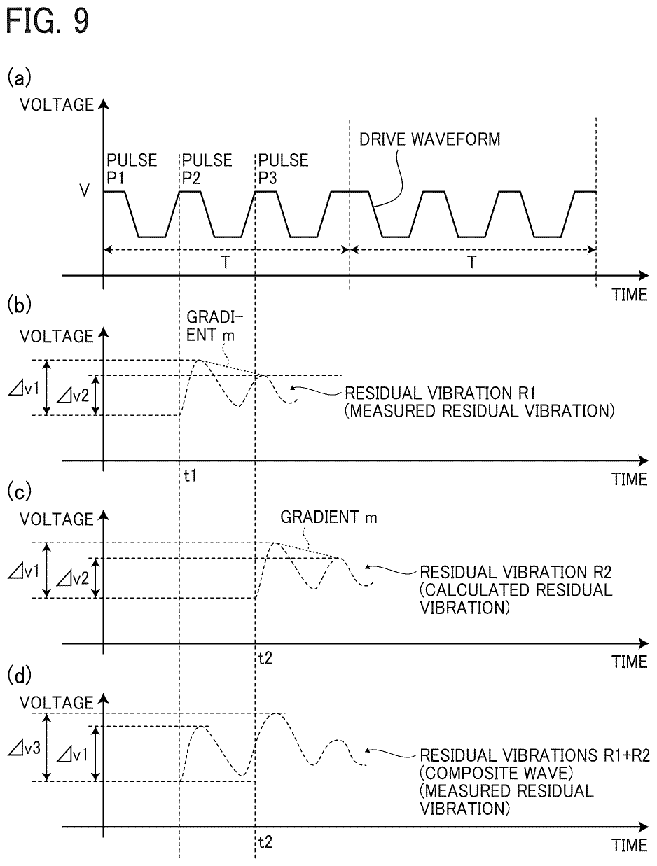

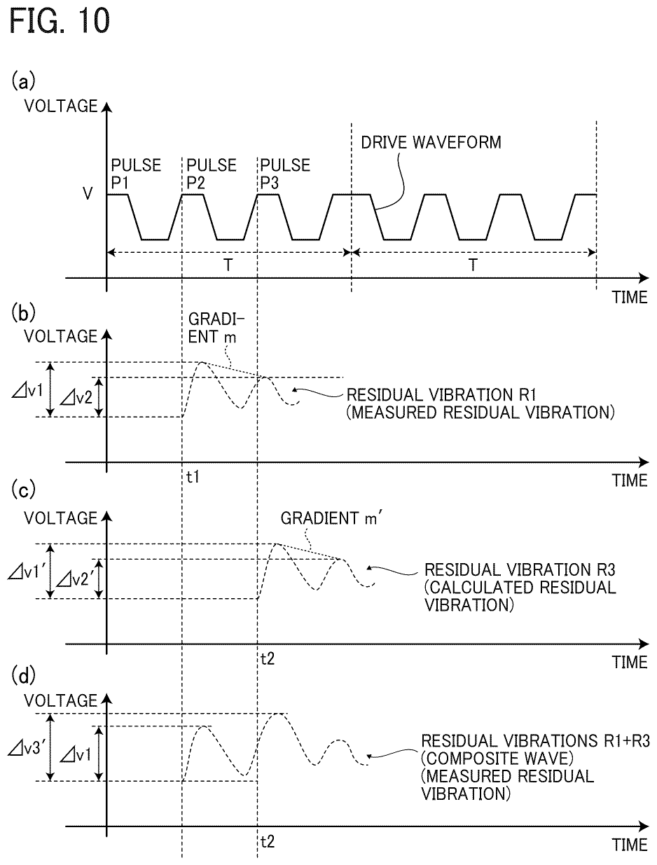

FIGS. 9 and 10 are diagrams for describing an example of a method of calculating residual vibration. FIG. 9 illustrates a method of calculating the residual vibration in a normal state, and FIG. 10 illustrates a method of calculating the residual vibration in an abnormal state (at the time of abnormality). In FIGS. 9 and 10, an example of calculating the residual vibration using the first pulse P1 and the second pulse P2 among the multiple drive pulses are be described below. The target for calculating the residual vibration for determining the state is not limited to the first and second pulses, and may be any other pulse.

The graph on the first row in FIG. 9 illustrates an example of the drive waveform similarly to the upper row in FIG. 8. The graph on the second row illustrates the residual vibration R1 in the normal state generated from the pulse P1. The residual vibration R1 corresponds to the residual vibration in the normal state generated from the pulse P1 measured in advance and stored in a storage circuit such as a read only memory (ROM).

The graph on the third row illustrates an example of the residual vibration R2. In the present embodiment, the residual vibration R2 is calculated by subtracting the residual vibration R1 illustrated in the graph on the second row from the composite wave (measured residual vibration) of the residual vibrations R1 and R2 illustrated in the graph on the fourth row. The residual vibration R2 corresponds to subtraction data calculated by subtracting the comparison data from the composite wave.

The graph on the fourth row shows an example of a composite wave of the residual vibrations R1 and R2. The composite wave of the residual vibrations R1 and R2 corresponds to the residual vibration in which the residual vibration R2 in the normal state generated from the pulse P2 is superimposed on the residual vibration R1, and is the residual vibration obtained by the measurement.

As described above, in the present embodiment, the residual vibration R2 is calculated by subtracting the residual vibration R1 from the composite wave of the residual vibrations R1 and R2. In the normal state, the residual vibration R2 is the same vibration as the residual vibration R1.

Therefore, it is possible to compare the stored residual vibration R1 with the calculated residual vibration R2 and determine that the state is the normal state based on the comparison result. For example, when the difference between the residual vibrations is equal to or smaller than the threshold value, it can be determined that the state is the normal state.

The graph on the first row in FIG. 10 illustrates an example of the drive waveform similarly to the upper row in FIG. 8 and the first row in FIG. 9. Similarly to the second row of FIG. 9, the graph on the second row shows the residual vibration R1 in the normal state generated from the pulse P1.

The graph on the third row shows an example of residual vibration R3 calculated in the case of the abnormal state. Similarly to the case of the normal state (FIG. 9), the residual vibration R3 is calculated by subtracting the residual vibration R1 illustrated in the graph on the second row from the composite wave (measured residual vibration) of the residual vibrations R1 and R3 illustrated in the graph on the fourth row. The residual vibration R3 corresponds to subtraction data calculated by subtracting the comparison data from the composite wave.

The graph on the fourth row shows an example of a composite wave of the residual vibrations R1 and R3. The composite wave of the residual vibrations R1 and R3 corresponds to the residual vibration in which the residual vibration R3 in the abnormal state generated from the pulse P2 is superimposed on the residual vibration R1, and is the residual vibration obtained by the measurement.

In the present embodiment, the residual vibration R3 is calculated by subtracting the residual vibration R1 from the composite wave of the residual vibrations R1 and R3. In the abnormal state, the residual vibration R3 is different from the residual vibration R1.

Hereinafter, the voltage amplitude of the first vibration of the residual vibration R3 is denoted by Δv1′, the voltage amplitude of the second vibration is denoted by Δv2′, and the voltage gradient between the amplitudes of the voltages of the first vibration and the second vibration is denoted by m′.

In the present embodiment, it is possible to compare the stored residual vibration R1 with the calculated residual vibration R3 and determine that the state is the abnormal state based on the comparison result. For example, when the difference between the residual vibrations is larger than the threshold value, it can be determined that the state is the abnormal state.

The comparison may be performed with some or all of the following variables of: a gradient m, an amplitude of voltage Δv1, and an amplitude of voltage Δv2.

For example, in the case of an abnormal state as illustrated in FIG. 10, the gradient m in the normal state and the gradient m′ in the abnormal state are compared, and the voltage amplitudes Δv1 and Δv2 in the normal state and the voltage amplitudes Δv1′ and Δv2′ in the abnormal state are compared. When the difference obtained by the comparison is larger than the threshold value, it is determined that the state is the abnormal state.

As described above, in the present embodiment, even in a state where the drive pulses for image formation are continuous, it is possible to detect the abnormality of the recording head (recording head 234, recording head 101) that discharges the droplets without requiring a long detection time until the residual vibration is settled. That is, it is possible to shorten the time for determining the state of the mechanism that discharges the liquid (liquid discharge head or the like).

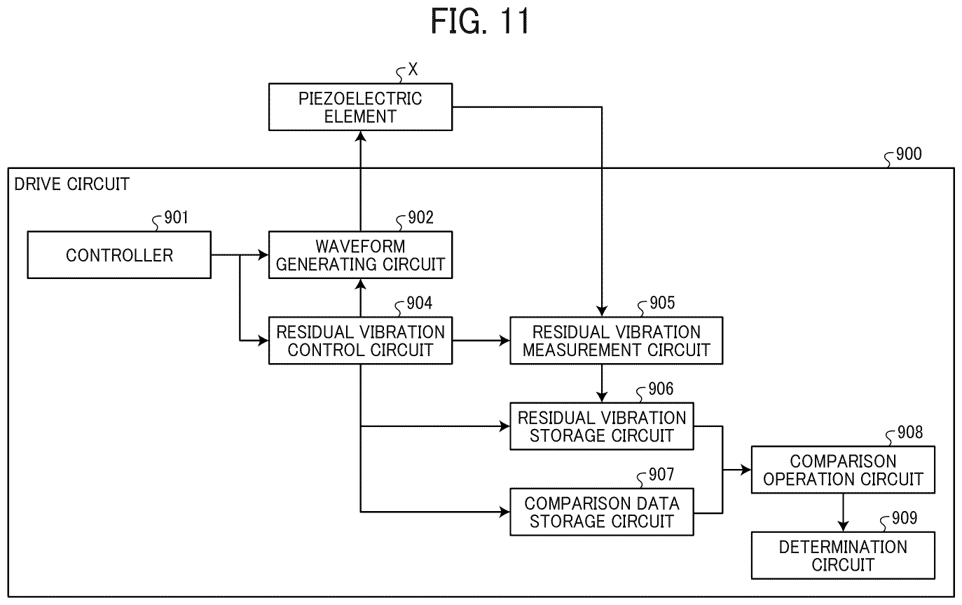

FIG. 11 is a diagram illustrating a configuration example of a circuit for detecting abnormality of a recording head (liquid discharge head). The circuit for detecting the abnormality can be realized as, for example, a drive circuit (circuit board) corresponding to the above-described head driver (such as a driver IC mounted on the FPC 7).

As illustrated in FIG. 11, a drive circuit 900 includes a controller 901, a waveform generating circuit 902, a residual vibration control circuit 904, a residual vibration measurement circuit 905, a residual vibration storage circuit 906, a comparison data storage circuit 907, a comparison operation circuit 908, and a determination circuit 909.

The controller 901 controls the entire processing for ejecting liquid from the recording head. The waveform generating circuit 902 generates and outputs the drive waveform as described above. For example, under the control of the controller 901, the waveform generating circuit 902 generates and outputs a drive waveform for driving the piezoelectric element X.

The residual vibration control circuit 904 instructs control of the residual vibration under the control of the controller 901.

The residual vibration measurement circuit 905 measures the residual vibration under the control of the residual vibration control circuit 904. For example, the residual vibration measurement circuit 905 measures measurement data representing residual vibration generated in a piezoelectric element that causes liquid to be discharged from a nozzle in response to multiple drive pulses applied within one printing cycle.

The residual vibration storage circuit 906 stores the residual vibration (measurement data) measured under the control of the residual vibration control circuit 904. The measurement data stored in the residual vibration storage circuit 906 corresponds to a composite wave (residual vibrations R1+R2, residual vibrations R1+R3) in the examples of FIGS. 9 and 10.

The comparison data storage circuit 907 stores comparison data to be compared with the measured residual vibration. The comparison data corresponds to data measured in advance as residual vibration generated when a specific drive pulse is applied among multiple drive pulses applied within one printing cycle.

The specific drive pulse is, for example, one drive pulse (for example, the first drive pulse) of multiple drive pulses applied within one printing cycle. The comparison data corresponds to the residual vibration R1 measured in advance in the examples of FIGS. 9 and 10.

Note that the residual vibration measurement circuit 905 measures measurement data representing residual vibration generated in the piezoelectric element according to multiple drive pulses including a specific drive pulse and a drive pulse applied next to the specific drive pulse. When the specific drive pulse is the first drive pulse, the measurement data is data representing the residual vibration generated in the piezoelectric element according to two drive pulses including the first drive pulse and the second drive pulse.

The comparison data may be changed according to the attributes of the ink, such as the type of ink used in the recording head, the temperature at which the ink is used, and the configuration of the liquid chamber in which the ink is stored. As a result, determination of the state according to the attribute of the recording head can be realized.

The residual vibration storage circuit 906 and the comparison data storage circuit 907 may be configured by any storage medium, and are configured by, for example, a storage medium such as a ROM.

The comparison operation circuit 908 performs a comparison operation using the measurement data stored in the residual vibration storage circuit 906 and the comparison data stored in the comparison data storage circuit 907, and outputs a comparison result. For example, the comparison operation circuit 908 first calculates the residual vibration (subtraction data) by subtracting the comparison data (residual vibration) from the measurement data (composite wave of residual vibration) stored in the residual vibration storage circuit 906. Thereafter, the comparison operation circuit 908 compares the calculated subtraction data with the comparison data.

The determination circuit 909 determines the state of the recording head (nozzle) using the comparison result by the comparison operation circuit 908. For example, the determination circuit 909 determines that the state of the recording head is the normal state when a difference obtained by comparing the calculated residual vibration with the comparison data is equal to or less than a threshold value. When the difference is larger than the threshold value, the determination circuit 909 determines that the state of the recording head is the abnormal state.

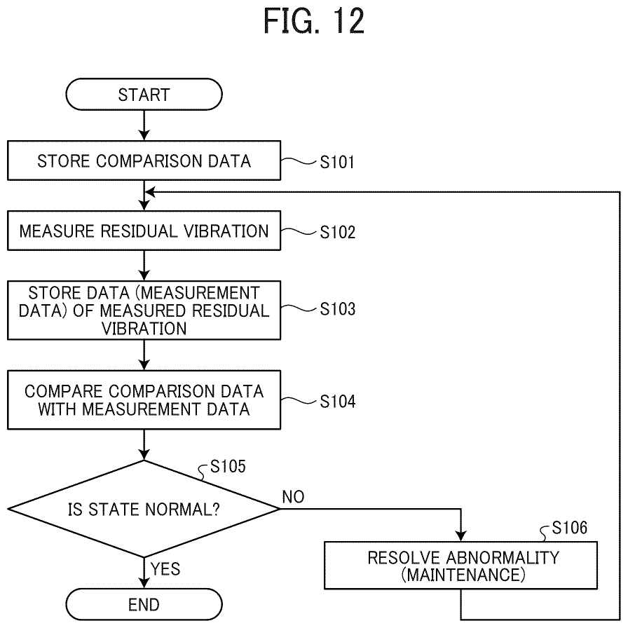

FIG. 12 is a flowchart illustrating an example of determination processing according to the present embodiment. The determination processing may be executed at any timing, and is executed, for example, when execution is instructed by a user or the like.

First, the drive circuit 900 measures the residual vibration in the normal state, and stores the measured residual vibration in the comparison data storage circuit 907 as comparison data (step S101).

The drive circuit 900 (residual vibration measurement circuit 905) measures a composite wave of the residual vibration (step S102). For example, the drive circuit 900 measures a composite wave of residual vibration within one printing cycle. In the examples of FIGS. 9 and 10, this step corresponds to measuring the residual vibrations R1+R2 or the residual vibrations R1+R3.

The drive circuit 900 (residual vibration measurement circuit 905) stores data (measurement data) of the measured residual vibration in the residual vibration storage circuit 906 (step S103).

The drive circuit 900 (comparison operation circuit 908) compares the comparison data with the measurement data (step S104).

The drive circuit 900 (determination circuit 909) determines whether the state of the recording head is normal by using the comparison result (step S105). When it is determined that the state is abnormal (step S105: No), a function for cleaning the nozzles to resolve the abnormality is executed (step S106).

For example, when it is determined that the state is abnormal, information indicating that abnormality has occurred is output. A user or the like instructs maintenance work to clean the nozzles to resolve abnormality of the recording head according to the output information. Thereafter, the process returns to step S102, and the process may be further continued.

When it is determined as normal (step S105: Yes), the determination processing ends.

As described above, according to the present embodiment, since a long detection time until the signal is attenuated is not required as in the prior art T1 or the like, the time for determining the state of the mechanism for discharging the liquid (liquid discharge head or the like) can be shortened.

According to the present embodiment, it is possible to shorten the time for determining the state of the mechanism that discharges the liquid.

Note that, in the above-described embodiment, although the image forming apparatus is a multifunction peripheral having at least two functions of copying, printing, scanning, and facsimile transmission, aspects of the present disclosure are applicable to any image forming apparatus such as a copier, a printer, a scanner, or a facsimile machine.

In the present embodiment, the pressure generator used in the liquid discharge head (recording head 234, recording head 101) is not limited. For example, in addition to the piezoelectric actuator (which may use a stacked piezoelectric element X) described in the above embodiment, a thermal actuator using an electrothermal transducer such as a thermal resistor, an electrostatic actuator including a diaphragm and a counter electrode, or the like may be used.

In the present specification, the terms “image formation,” “recording,” “printing,” “image printing,” and “fabricating” used herein may be used synonymously with each other.

In the present embodiment, the liquid discharger is formed by integrating a functional component and a mechanism with a liquid discharge head, and is an assembly of components related to liquid discharge. For example, the liquid discharger includes a combination of the liquid discharge head with at least one of a head tank, a carriage, a supply mechanism, a maintenance recovery mechanism, or a main scanning moving mechanism.

Here, the integration refers to, for example, a way through which the liquid discharge head and the functional components or the mechanisms are fixed to each other by, for example, fastening, adhesion, or engagement, or a way through which the liquid discharge head is held movably relative to the functional components or the mechanisms, vice versa. The liquid discharge head, the functional components, and the mechanisms may be detachably attached to each other.

For example, as the liquid discharger, there is a unit in which the liquid discharge head and the head tank are integrated. Alternatively, the liquid discharge head and the head tank (for example, the head tank 235) coupled with a tube or the like may form the liquid discharger as a single unit. Here, a unit including a filter can be added between the head tank and the liquid discharge head of the liquid discharger.

As the liquid discharger, there is a unit in which the liquid discharge head and the carriage (for example, the carriage 233) are integrated.

As the liquid discharger, there is a unit in which the liquid discharge head is movably held on the guide member that constitutes a part of the scanning moving mechanism, and the liquid discharge head and the scanning moving mechanism are integrated. There is one that the liquid discharge head, the carriage, and the main scanning moving mechanism are integrated to form a single unit.

As the liquid discharger, there is a unit in which a cap member (for example, the caps 282a and 282b) that is part of the maintenance recovery mechanism (for example, the maintenance recovery mechanism 281) is fixed to the carriage to which the liquid discharge head is attached, and the liquid discharge head, the carriage, and the maintenance recovery mechanism are integrated.

As the liquid discharger, there is a unit in which tubes (for example, the supply tube 236) is coupled to the head tank or the liquid discharge head with a channel part attached thereto, and the liquid discharge head and the supply mechanism are integrated. A liquid in a liquid reservoir source is supplied to the liquid discharge head through this tube.

The main scanning moving mechanism may be a guide member only. The supply mechanism may be a tube(s) only or a loading unit only.

In the present embodiment, an apparatus discharging liquid (liquid discharge apparatus) includes the liquid discharge head or the liquid discharger, and drives the liquid discharge head to discharge liquid. The liquid discharge apparatus may be, for example, an apparatus that can discharge liquid to a material to which liquid can adhere or an apparatus discharging a liquid toward gas or into liquid.

The liquid discharge apparatus may also include a unit related to feeding, conveying, and sheet ejection of an object to which liquid can adhere, a preprocessing apparatus, a post-processing apparatus, and the like.

The liquid discharge apparatus may be, for example, an image forming apparatus to form an image on a sheet by discharging ink, or a stereoscopic fabrication apparatus (three-dimensional fabrication apparatus) to discharge fabrication liquid to a powder layer in which powder material is formed in layers to fabricate a stereoscopic fabrication object (three-dimensional fabrication object).

The liquid discharge apparatus is not limited to an apparatus that discharges liquid to visualize meaningful images such as letters or figures. For example, the liquid discharge apparatus may be an apparatus that forms patterns having no meaning or an apparatus that fabricates three-dimensional images.

In the present embodiment, the term “material on which liquid can be adhered” represents a material onto which liquid is at least temporarily adhered, a material onto which liquid is adhered and fixed, or a material into which liquid adheres and permeates. Specific examples thereof include recording media such as paper, recording paper, recording paper, films, and cloth, electronic components such as electronic substrates and piezoelectric elements, and media such as powder layers (powder layers), organ models, and inspection cells, and include all those to which liquid adheres unless otherwise specified.

A liquid discharge head includes: a nozzle plate having a nozzle to discharge a liquid; a channel plate having a pressure chamber communicating with the nozzle; a diaphragm defining a part of the pressure chamber; a piezoelectric element to vibrate the diaphragm to discharge the liquid in the pressure chamber from the nozzle; and a drive circuit configured to: apply, to the piezoelectric element, multiple drive pulses including a specific drive pulse within one printing cycle, to drive the piezoelectric element to vibrate the diaphragm; measure a first residual vibration (R1+R3) generated in the piezoelectric element by the multiple drive pulses; compare: the first residual vibration (R1+R3) measured from the piezoelectric element; and comparison data of a second residual vibration (R1) measured in advance by applying, to the piezoelectric element, the specific drive pulse among the multiple drive pulses; and determine a state of the nozzle based on a comparison between the first residual vibration (R1+R3) and the comparison data (R1).

The drive circuit is further configured to: apply, to the piezoelectric element, multiple drive pulses including the specific drive pulse including: one drive pulse (P1) within the one printing cycle; and another drive pulse (P2) next to the one drive pulse (P1) within the one printing cycle; measure the first residual vibration (R1+R3) generated in the piezoelectric element by the multiple drive pulses including the one drive pulse (P1) and said another drive pulse (P2); subtract the second residual vibration (R1) of the comparison data from the first residual vibration (R1+R3) to obtain a third residual vibration (R3), the second residual vibration measured in advance by applying, to the piezoelectric element, the one drive pulse (P1) among the multiple drive pulses; and compare the second residual vibration (R1) and the third residual vibration (R3) to determine the state of the nozzle.

The drive circuit is further configured to: calculate a difference between the second residual vibration (R1) and the third residual vibration (R3); and determine that the state of the nozzle is in a normal state, when the difference is equal to or smaller than a threshold value; and determine that the state of the nozzle is in an abnormal state, when the difference is larger than the threshold value.

The drive circuit is further configured to change the comparison data according to attributes of ink including: a type of the liquid to be discharged from the nozzle, a temperature at which the liquid is used, and a configuration of the pressure chamber.

The drive circuit is further configured to: measure a first amplitude of a voltage (Δv1′) in the third residual vibration (R3), calculate a difference between the first amplitude of the voltage (Δv1′) and a second amplitude of a voltage (Δv1) in the second residual vibration (R1) of the comparison data, to determine the state of the nozzle.

The drive circuit is further configured to: measure a first amplitude of a voltage (Δv1′) in the third residual vibration (R3), calculate a first gradient (m′) in the first amplitude of the voltage (Δv1′); and calculate a difference between the first gradient (m′) and a second gradient (m) in a second amplitude of a voltage (Δv1) in the second residual vibration (R1) of the comparison data, to determine the state of the nozzle.

An image forming apparatus includes: the liquid discharge apparatus according to claim 7 to: discharge an ink as the liquid from the liquid discharge head to the medium conveyed by the conveyor to form an image on the medium.

A drive circuit includes: circuitry configured to: apply, to a piezoelectric element of a liquid discharge head, multiple drive pulses including a specific drive pulse within one printing cycle to drive the piezoelectric element; measure a first residual vibration generated in the piezoelectric element by the multiple drive pulses; compare: the first residual vibration measured from the piezoelectric element; and comparison data of a second residual vibration measured in advance by applying, to the piezoelectric element, the specific drive pulse among the multiple drive pulses; and determine a state of a nozzle of the liquid discharge head based on a comparison between the first residual vibration and the comparison data.

A drive method includes: applying, to a piezoelectric element of a liquid discharge head, multiple drive pulses including a specific drive pulse within one printing cycle to drive the piezoelectric element; measuring a first residual vibration generated in the piezoelectric element by the multiple drive pulses; comparing: the first residual vibration measured from the piezoelectric element; and comparison data of a second residual vibration measured in advance by applying, to the piezoelectric element, the specific drive pulse among the multiple drive pulses; and determining a state of a nozzle of the liquid discharge head based on a comparison between the first residual vibration and the comparison data.

Examples of the material on which liquid can be adhered include any materials on which liquid can be adhered even temporarily, such as paper, thread, fiber, fabric, leather, metal, plastic, glass, wood, and ceramic.

The liquid includes any liquid having a viscosity or a surface tension that is dischargeable from the liquid discharge head, and, preferably, the viscosity of the liquid is not greater than 30 mPa·s under ordinary temperature and ordinary pressure or by heating or cooling. More specific examples thereof include a solution, a suspension, or an emulsion including, for example, a solvent, such as water or an organic solvent, a colorant, such as dye or pigment, a functionality imparting material, such as a polymerizable compound, a resin, a surfactant, a biocompatible material, such as DNA, amino acid, protein, or calcium, and an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The liquid discharge apparatus may be an apparatus to relatively move a liquid discharge head and a material on which liquid can be adhered, but is not limited to such an apparatus. Specific examples thereof include a serial type apparatus that moves the liquid discharge head or a line type apparatus that does not move the liquid discharge head.

Examples of the liquid discharge apparatus further include a treatment liquid coating apparatus to discharge a treatment liquid to a sheet to apply the treatment liquid to the surface of the sheet to reform the sheet surface and an injection granulation apparatus in which a composition liquid including raw materials dispersed in a solution is injected through nozzles to granulate fine particles of the raw materials.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge head comprising:
a nozzle plate having a nozzle to discharge a liquid;
a channel plate having a pressure chamber communicating with the nozzle;
a diaphragm defining a part of the pressure chamber;
a piezoelectric element to vibrate the diaphragm to discharge the liquid in the pressure chamber from the nozzle; and
a drive circuit configured to:
apply, to the piezoelectric element, multiple drive pulses including a specific drive pulse within one printing cycle,
to drive the piezoelectric element to vibrate the diaphragm;
measure a first residual vibration generated in the piezoelectric element by the multiple drive pulses;
compare:
the first residual vibration measured from the piezoelectric element; and
comparison data of a second residual vibration measured in advance by applying, to the piezoelectric element, the specific drive pulse among the multiple drive pulses; and
determine a state of the nozzle based on a comparison between the first residual vibration and the comparison data.

2. The liquid discharge head according to claim 1,
wherein the drive circuit is further configured to:
apply, to the piezoelectric element, multiple drive pulses including the specific drive pulse including:
one drive pulse within the one printing cycle; and
another drive pulse next to the one drive pulse within the one printing cycle;
measure the first residual vibration generated in the piezoelectric element by the multiple drive pulses including the one drive pulse and said another drive pulse;
subtract the second residual vibration of the comparison data from the first residual vibration to obtain a third residual vibration,
the second residual vibration measured in advance by applying, to the piezoelectric element, the one drive pulse among the multiple drive pulses; and
compare the second residual vibration and the third residual vibration to determine the state of the nozzle.

3. The liquid discharge head according to claim 2,
wherein the drive circuit is further configured to:
calculate a difference between the second residual vibration and the third residual vibration; and
determine that the state of the nozzle is in a normal state,
when the difference is equal to or smaller than a threshold value; and
determine that the state of the nozzle is in an abnormal state,
when the difference is larger than the threshold value.

4. The liquid discharge head according to claim 1,
wherein the drive circuit is further configured to change the comparison data according to attributes of ink including:
a type of the liquid to be discharged from the nozzle,
a temperature at which the liquid is used, and
a configuration of the pressure chamber.

5. The liquid discharge head according to claim 3,
wherein the drive circuit is further configured to:
measure a first amplitude of a voltage in the third residual vibration,
calculate a difference between the first amplitude of the voltage and a second amplitude of a voltage in the second residual vibration of the comparison data,
to determine the state of the nozzle.

6. The liquid discharge head according to claim 5,
wherein the drive circuit is further configured to:
measure a first amplitude of a voltage in the third residual vibration,
calculate a first gradient in the first amplitude of the voltage; and
calculate a difference between the first gradient and a second gradient in a second amplitude of a voltage in the second residual vibration of the comparison data,
to determine the state of the nozzle.

7. A liquid discharge apparatus comprising:
the liquid discharger head according to claim 1; and
a conveyor to convey a medium onto which the liquid discharge head discharges the liquid.

8. An image forming apparatus comprising:
the liquid discharge apparatus according to claim 7 to:
discharge an ink as the liquid from the liquid discharge head to the medium conveyed by the conveyor to form an image on the medium.

9. A drive circuit comprising:
circuitry configured to:
apply, to a piezoelectric element of a liquid discharge head, multiple drive pulses including a specific drive pulse within one printing cycle to drive the piezoelectric element;
measure a first residual vibration generated in the piezoelectric element by the multiple drive pulses;
compare:
the first residual vibration measured from the piezoelectric element; and
comparison data of a second residual vibration measured in advance by applying, to the piezoelectric element, the specific drive pulse among the multiple drive pulses; and
determine a state of a nozzle of the liquid discharge head based on a comparison between the first residual vibration and the comparison data.

10. A drive method comprising:
applying, to a piezoelectric element of a liquid discharge head, multiple drive pulses including a specific drive pulse within one printing cycle to drive the piezoelectric element;
measuring a first residual vibration generated in the piezoelectric element by the multiple drive pulses;
comparing:
the first residual vibration measured from the piezoelectric element; and
comparison data of a second residual vibration measured in advance by applying, to the piezoelectric element, the specific drive pulse among the multiple drive pulses; and
determining a state of a nozzle of the liquid discharge head based on a comparison between the first residual vibration and the comparison data.
